(19) United States
(12) Patent Application Publication
(10) Pub. No.: US 2024/0232149 A9
(43) Pub. Date: Jul. 11, 2024

(54) RELATIONAL DATABASE SYSTEM

(71) Applicant: Raimund Reisacher, Nürnberg (DE)

(72) Inventor: Raimund Reisacher, Nürnberg (DE)

(21) Appl. No.: 18/546,624

(22) PCT Filed: Jan. 25, 2022
(86) PCT No.: PCT/EP2022/051557

§ 371 Date: Aug. 16, 2023

(30) Foreign Application Priority Data
Feb. 16, 2021 (DE) 10 2021 103 571.6

(51) Int. Cl. G06F 16/21

(52) U.S. Cl. CPC G06F 16/213

(57) ABSTRACT

A relational database system, implementable on a computer system with at least one processor and a storage unit, includes at least one relational database with a database structure including a multiplicity of interlinked database tables for receiving data to be processed, each database table having a table name and a multiplicity of table columns identifiable by respective table column names. The table column names, as identifiers, are formed of a plurality of different uniquely identifiable table column name naming schemes, contain one or more word formations of identifiable individual words and are syntactically and semantically evaluable by program routines, and/or the table names, as identifiers, are formed of one or more different uniquely assignable table name naming schemes, including at least one table type, a table code name, an optional table name extension, and preferably a database naming scheme and are syntactically and semantically evaluable by program routines.

The invention relates to a relational database system according to the preamble of claim 1.

The classical way of generating databases and the application software they use is characterized by the use of complex development systems, partially automated process steps, a large number of third-party libraries and specific data integration models, in order to achieve a result as quickly as possible.

This complexity creates a serious lack of transparency, which means that the entire process of creating applications and the databases associated with them can no longer be automated. The degree of standardization is also low, as standardization processes are only applied at a late stage, typically to applications that have already been completed.

Another problem is that change requests for the applications usually involve a large amount of effort and therefore lead to high costs, which often leads to the failure of entire projects. Similarly, when changes are made to the applications and their underlying databases in the known database systems, the frequency of errors and the testing effort are very high due to the complexity.

For example, a simple ERP (enterprise resource planning) system for managing a company might contain 150 tables. If a developer wants to add another company to this ERP system, for example, the new company will need 120 new tables, with 30 tables being shared by both companies.

In the classical programming approach, to implement this ERP extension automatically, additional definitions must be used and managed and forwarded to the database and user interfaces, which very quickly leads to non-transparency and error susceptibility.

A similar database system is described in US 2003/0229610. Here, by introducing a new “link column” element at the level of the database definition language (Data Definition Language), a method and a tool are created for implicitly defining and managing primary keys and their associations with object methods, and a naming method of primary keys by table name and link columns as well as by referenced column names is used to provide a simplified and more secure handling of relations.

Another such database system is described in US 2009/0024642. Here, metadata in the form of additional objects and XML files is generated to represent database structures and to enable a database to be reconstructed independently of the database definition language.

Accordingly, an object of the present invention is to create a relational database system which makes it possible to standardize the entire software development process to a high degree and to carry out tasks automatically from data management to the finished application, thus freeing administrators and developers from routine tasks. The principles of low-code and no-code (LCNC) will be implemented in depth throughout.

This object is achieved according to the invention by means of a relational database having the features of claim 1.

The present invention realizes the intention behind the above-mentioned prior art documents without the expense of additional objects and without additional structure representations, substantially simplified by machine-interpretable and human-readable naming schemes of tables and table columns, which, with their syntax using a plurality of structural levels and dedicated word conventions, contain information about dynamic relations, data type, data use and more. This enables automated generation of databases and integrated user interfaces using simple algorithms. This can significantly increase software quality and reduce the error rate by over 90%. In addition, development times and testing effort can be reduced by over 90%, which can sometimes reduce software development costs by over 90%.

It represents a particular advantage of the invention that, by simplifying and standardizing, highly complex software systems can be generated in large part automatically using simple algorithms.

Put simply, the technical problem of lack of transparency and lack of automation capability of classical data systems and classical applications is eliminated according to the invention by means of transparent naming definitions that can be implemented automatically, which will be discussed in detail below.

The novel combination of multi-level syntax definitions and an accumulative interpretation of specific name components (words) of identifiers advantageously allows a simplified dynamic multiple usage of data structures with dynamic links (copying and pasting tables), static type control of data structures and program code, simplified generation and porting of program code, automated data management and automated generation of user interfaces with data integrations.

According to the invention, a relational database system, which is implemented in particular on a computer system with one or more processors and at least one storage unit, or stored in the storage unit of the computer system and can be executed by the computer system, comprises at least one relational database with a database structure, comprising a plurality of interlinked database tables for storing data to be processed, each database table having a table name and a plurality of table columns identified by respective table column names. Although in the simplest case the computer system can also be a personal computer on which the database system according to the invention is implemented and executed for test purposes in a static mode, e.g. in a simulated or virtualized client server environment, the computer system is preferably a client server system having one or more servers arranged in a data center or distributed at different locations, each connected to one or more client computers in a known manner for data exchange, and each client computer of which, in addition to the server, also has at least one processor and preferably at least one working storage unit connected to it.

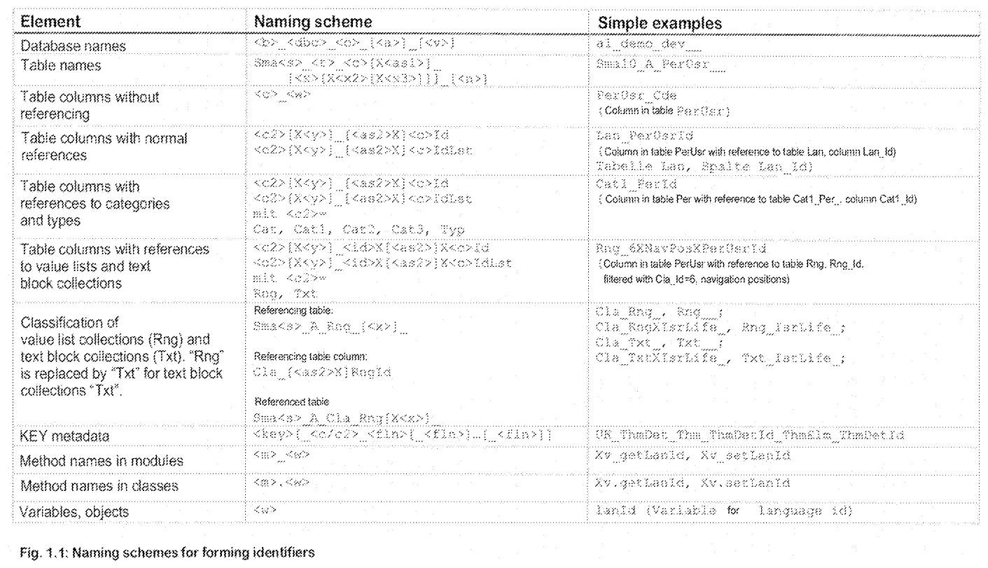

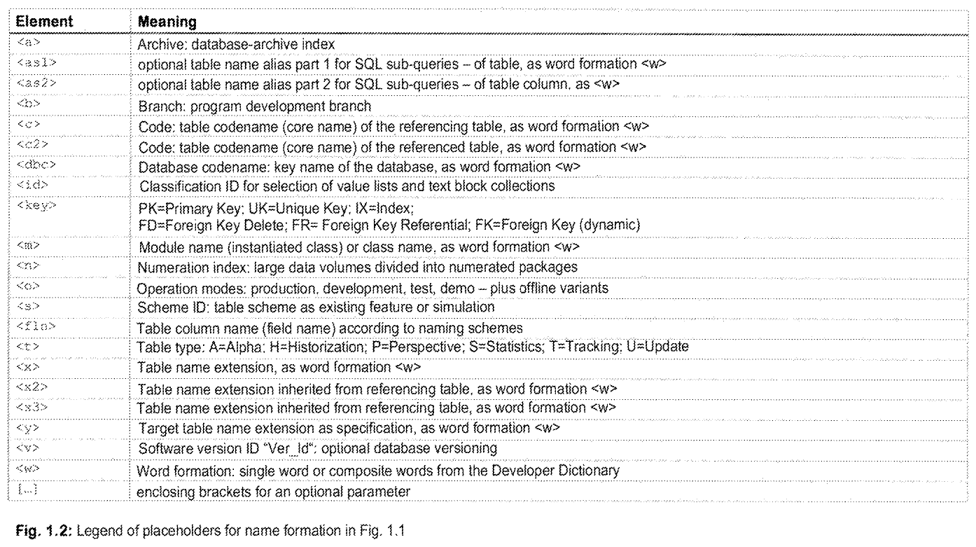

The relational database system is characterized in that table column names, as identifiers, consist of a plurality of different but uniquely assignable naming schemes, contain one or more word formations and can be syntactically and semantically evaluated by means of program routines, and/or that the table names, as identifiers, consist of one or more different uniquely assignable table name naming schemes, which comprise at least one table type, a table code name, an optional table name extension, and preferably a database naming scheme and which can be syntactically and semantically evaluated by means of program routines. Examples of naming schemes for table names and table column names are shown in FIG. 1.1 with the associated placeholder legend in FIG. 1.2. Depending on the application, four different table column naming schemes are used here, which can be uniquely distinguished from each other by format, parameter use, starting word and ending words. Naming schemes and word formations can thus be evaluated syntactically and semantically by means of program routines.

According to the invention, identifiers that can be evaluated syntactically and semantically allow the tables to be advantageously reproduced by simply copying the table structures, and all the information about linguistic names that is necessary for linking tables and table columns, for example, to be incorporated into the tables themselves, so that new linkages can be automatically set up using simple algorithms anchored in the identifiers and, due to the linguistic transparency created, the existing user interfaces can continue to be used without reprogramming.

Furthermore, through the use of the invention allows a high degree of standardization to be achieved, and robot process automation (RPA) systems can independently modify or regenerate databases and customize interfaces and functionalities without the need to recompile program code.

The inclusion of table names as identifiers in a naming scheme that can be interpreted syntactically and semantically by program routines enables the automated management of tables across database naming schemes <s>, types of standardized table uses <t>, multiple use of table structures by means of name extensions <x> and numbered series tables <n>. For server types that do not have their own scheme management, a schema is preferably simulated automatically.

According to a further idea underlying the invention, the relational database system comprises a plurality of relational databases, the database names of which are integrated as identifiers into a naming scheme that can be syntactically and semantically evaluated by means of program routines or are structured according to such a naming scheme. This enables a database management system to automatically include program development branches <b>, database operation modes <o>, archive databases <a> and software version numbers <v> using program routines. The parameters <b>, <o> and <v> are specifically used to implement an integral development and production system in which executions, comparisons, tests and derivations of databases and programming code can be implemented across all development branches, operation modes and software versions.

Furthermore, the naming schemes can include a substructuring, which is effected by a primary separator, in particular a “_”, into primary elements, and using a secondary separator, in particular the capital letter “X”, can be structured into secondary elements within the primary elements. If necessary, this structuring can be refined with additional separators. A syntactic and semantic analysis by means of program routines can thus be carried out across multiple structure levels and word formations.

According to a further idea underlying the invention, it may be provided to extend the syntactic and semantic interpretability of identifiers by storing the individual words of the word formations <w> in particular in a separate developer dictionary containing word specifications, such as data format, input and output formatting, meta information, prefix functionality, class and module name functionality, keyword indicators, and usability. The word formations themselves can thus also be evaluated syntactically and semantically.

In this case, it may be provided that the developer dictionary is configured to be used in particular for the syntactic and semantic verification of the use of identifiers such as table column names and/or table names and/or database names and/or identifiers in program codes. This exploits the additional word information available and puts it into a practically processable framework.

According to a further idea of the invention, identifiers in program codes preferably provide the source for all types of contextual information required for an isolated porting of declarations and methods within the program code, so that the entire program code does not need to be used in order to port a code sequence. This is made possible within program codes by the syntactic and semantic interpretability of identifiers, because additional information from the developer dictionary identifies their data types and purpose, for example, even in non-typed programming languages. This greatly simplifies and speeds up the porting of modified program sequences to different programming platforms, and graphic and/or text-based interpreters can also be used to automate processes in a simplified manner.

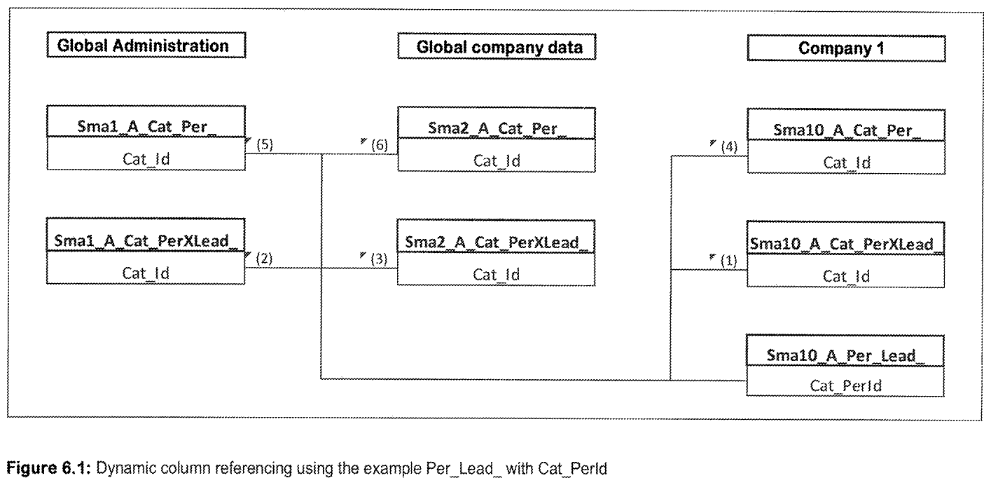

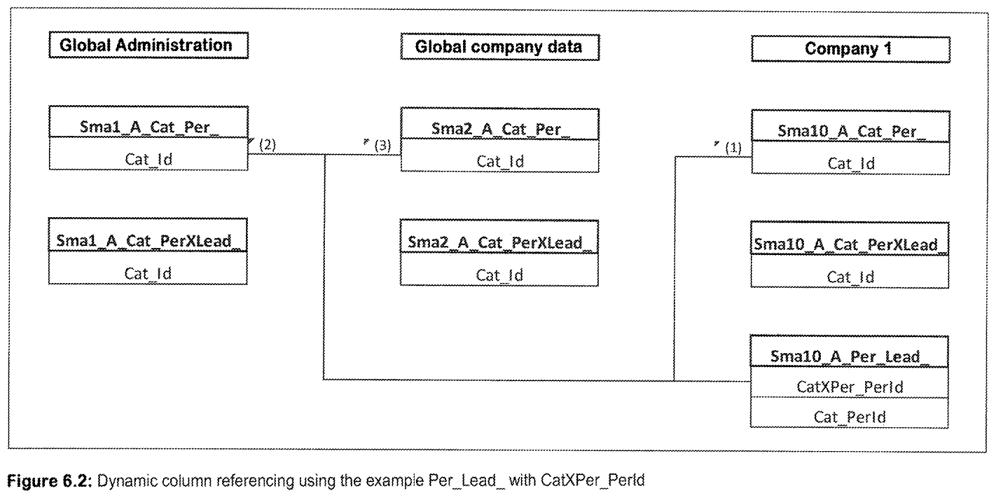

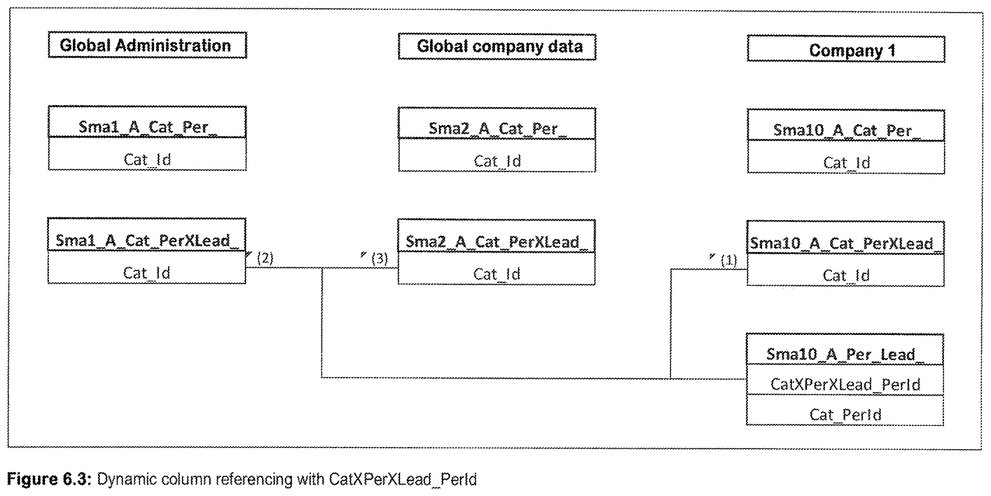

According to a further idea according to the invention, table column identifiers, such as those specified in FIGS. 1.1 and FIGS. 6.1 to 6.3, can be used to dynamically reference table columns to tables so that copied tables reference different target tables in a context-dependent manner, depending on their scheme and their name extension, by means of different prioritizations.

According to a further idea underlying the invention, table column identifiers, optionally supported by metadata, the tasks of interface generation, interface customization, data integrations and functionalities connoted with identifiers can be implemented automatically by means of program routines for database structures and thus the entire database can be designed to be editable in a standardized form on a user interface and provided with specific functionalities and behaviors.

According to a further idea underlying the invention, IDs of a reference can be concatenated in text form by means of separators in order to form an ID list, which is also dynamically referenced and can be evaluated automatically. In other words, individual IDs are referenced to ID lists, so that IDs listed in text form and separated with separators can also be dynamically referenced to tables and evaluated automatically.

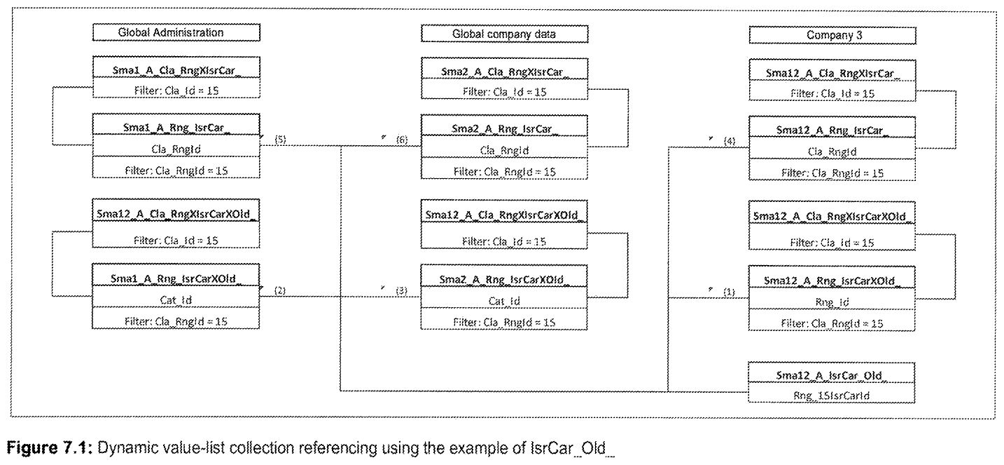

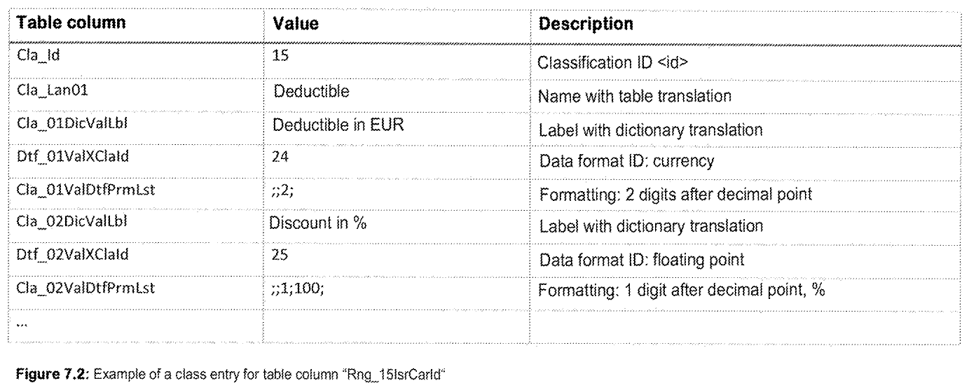

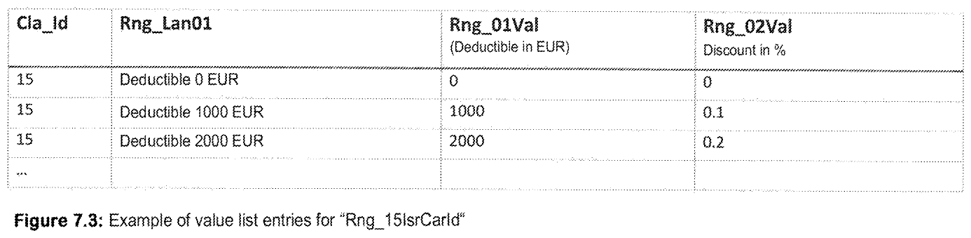

A further dimension can furthermore be advantageously added to the dynamic referencing, allowing it to access collections within referenced tables automatically. This is explained according to FIG. 7.1 on the basis of a value list collection and can also be transferred to other collections, such as text block collections. Collections are specified in these examples using a classification table “Cla”, which is permanently assigned to a collection and is clearly identifiable from the table name composition.

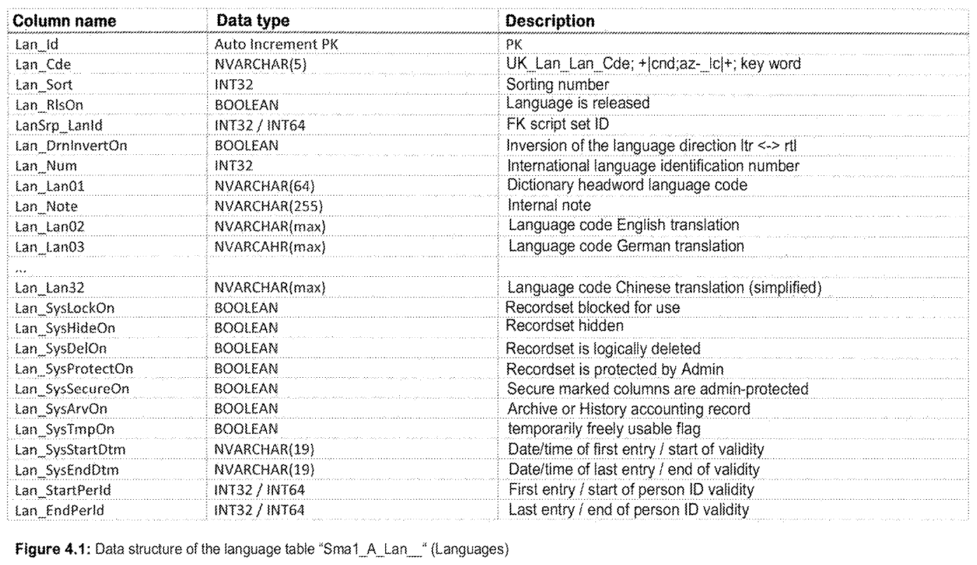

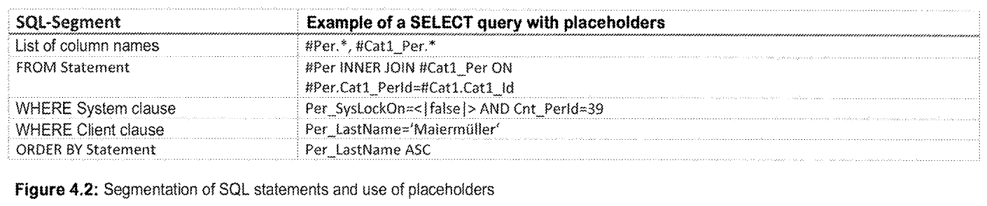

Another embodiment according to the invention is described in FIG. 4.2 using an exemplary data query. Since database names, table names, and table column names are defined syntactically and semantically by means of identifiers, SQL statements can now be formulated with placeholders that are automatically completed in a context-dependent manner for execution and thus address, for example, target databases and target tables with their table columns automatically and dynamically. An SQL statement can thus be formulated in abstract terms.

It is also possible to segment an SQL statement into different sections that can be handled independently and reassembled for execution. On the one hand, this simplifies the modification of a single section so that conditions (WHERE clauses) and sorting operations (SORT BY clauses) can be modified individually, for example, without needing to take the overall statement into account. Secondly, the statements can be divided into security-related sections that cannot be modified by the client, and into client-side modifiable sections, increasing the security of the database system against manipulation.

The invention will be described below with reference to the drawings and on the basis of preferred embodiments.

In the drawings:

FIG. 1.1 shows a tabular listing of exemplary naming schemes for the formation of identifiers, for example for databases, tables, table columns, value list and text block collections and other elements,

FIG. 1.2 shows a legend for the placeholders listed in FIG. 1.1,

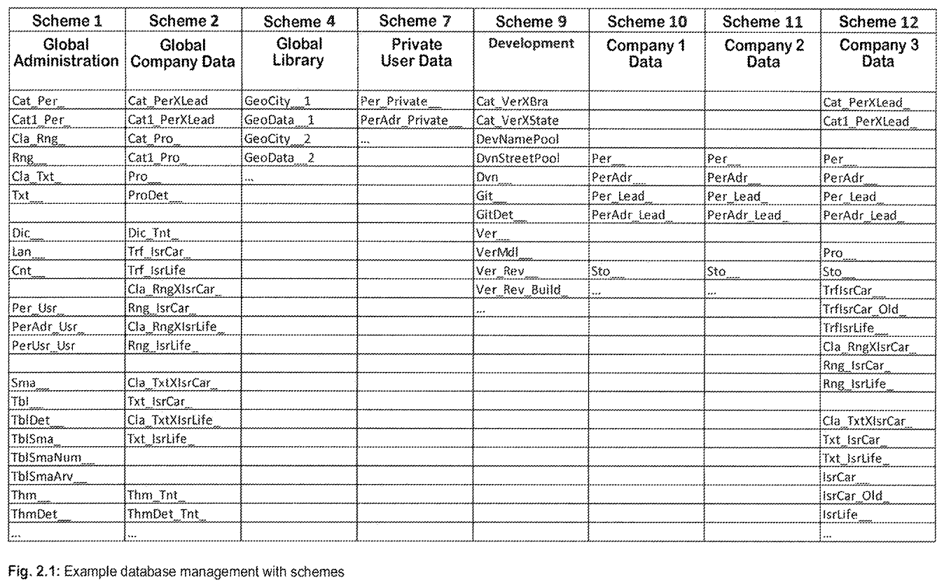

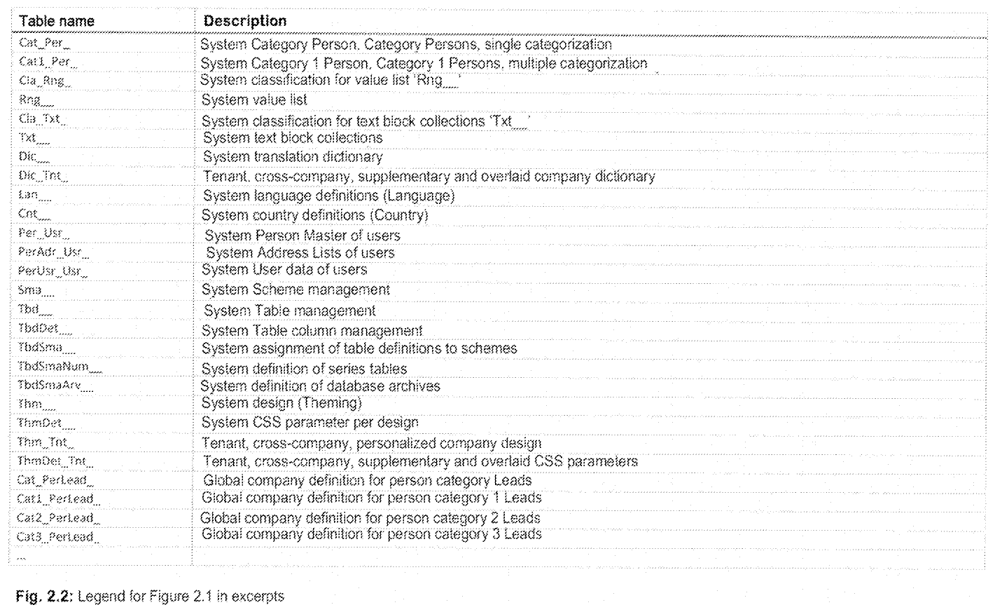

FIG. 2.1 shows an example of database management with schemes,

FIG. 2.2 shows excerpts of explanations of the table name identifiers stored in FIG. 2.1,

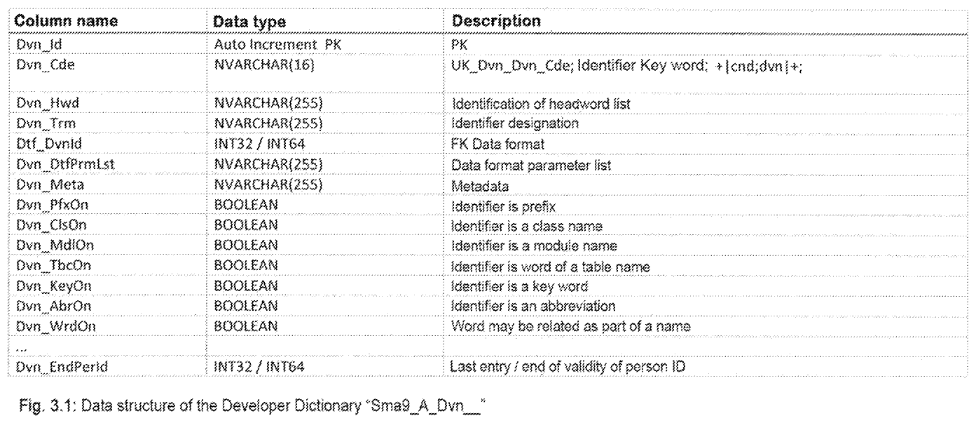

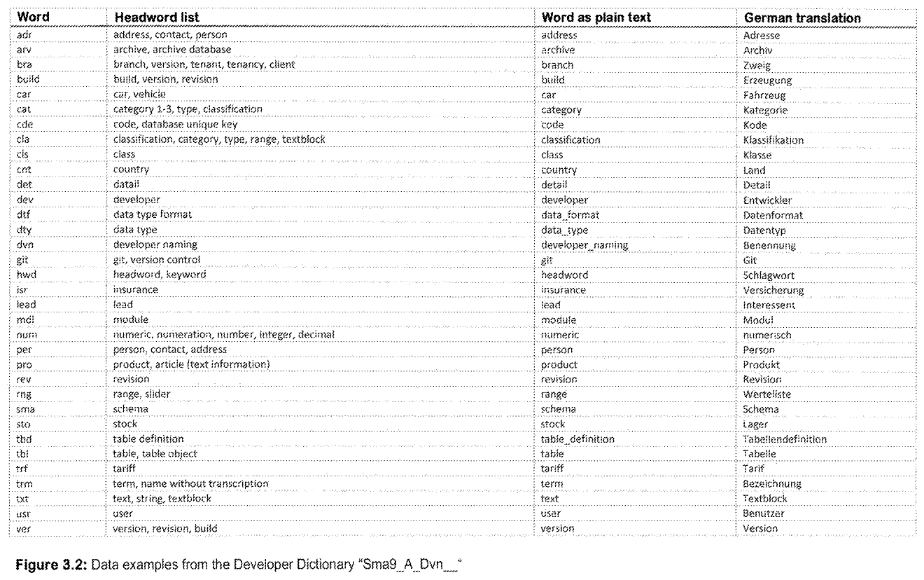

FIG. 3.1 shows an example of the data structure of the developer dictionary with the designation “Sma9_A_Dvn_”,

FIG. 3.2 shows data examples from the developer dictionary with the designation “Sma9_A_Dvn_”,

FIG. 4.1 shows excerpts of the example table column names used in the table “Sma1_A_Lan_” (languages) with an indication of the respective data type and an associated description of the table column,

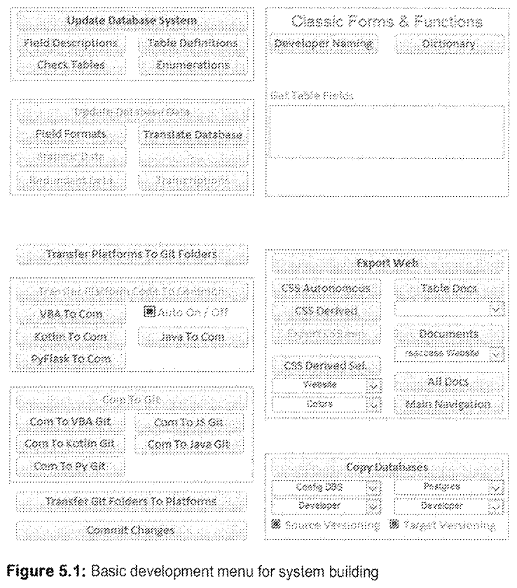

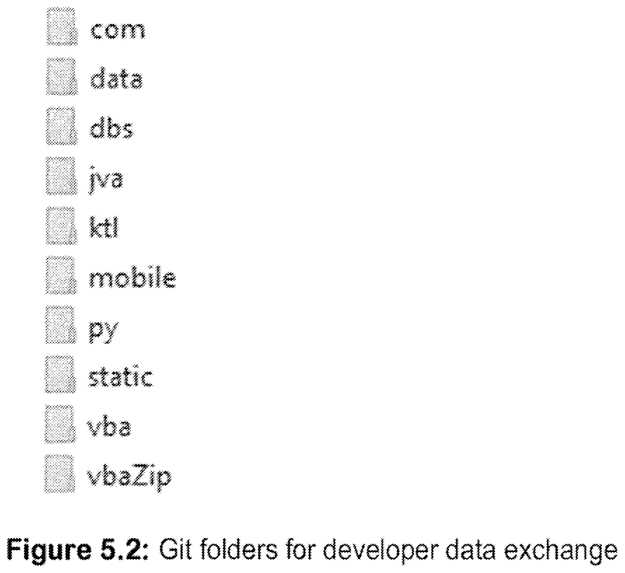

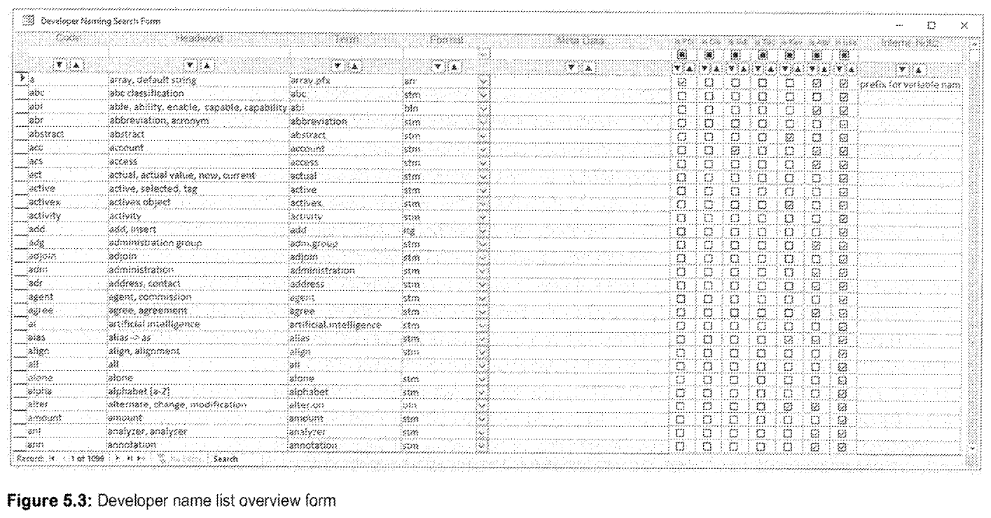

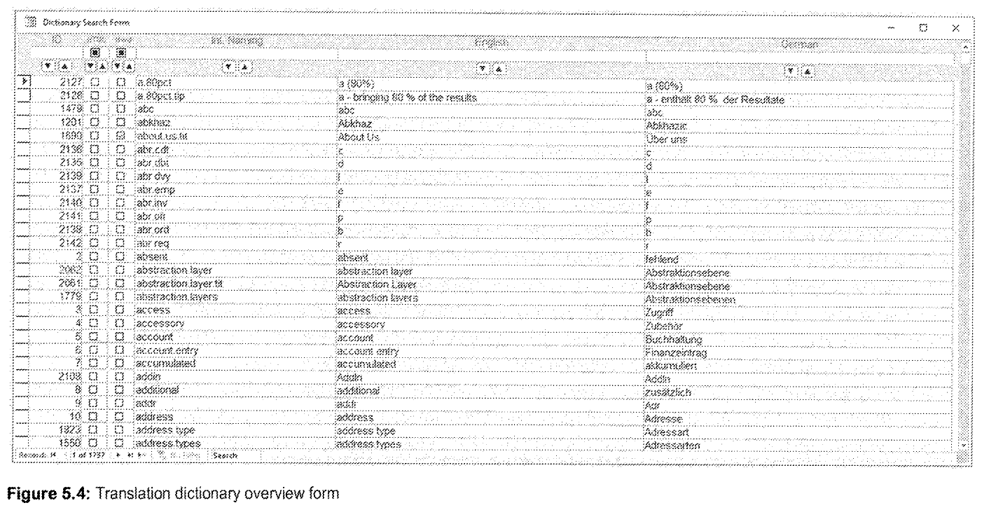

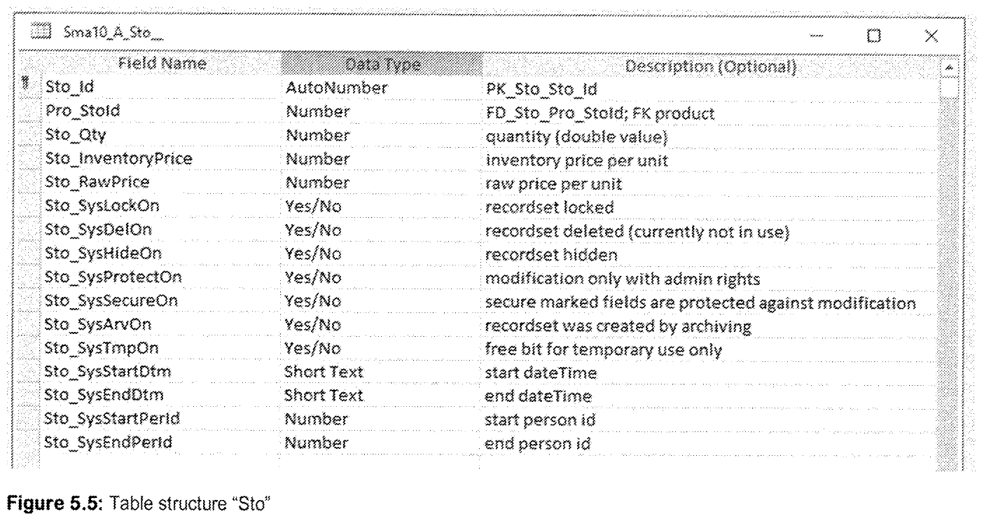

FIG. 5.1 shows a representation of the basic development menu of a user interface for carrying out different actions with a relational database system according to the invention,

FIG. 5.2 shows a representation of the selectable Git folders for developer data exchange,

FIG. 5.3 shows a representation of an overview form for exemplary developer dictionary entries,

FIG. 5.4 shows a representation of an overview form for an exemplary translation dictionary,

FIG. 5.5 shows an exemplary table structure with the designation “Sto” for the storage of products,

FIG. 6.1 shows a dynamic table column referencing using the example of Per_Lead_ using a table column name “Cat_PerId”,

FIG. 6.2 shows a dynamic table column referencing using the example of Per_Lead_ using a table column name “CatXPer_PerId”,

FIG. 6.3 shows a dynamic table column referencing using the example of Per_Lead_ using a table column name “CatXPerXLead_PerId”,

FIG. 7.1 shows a value list collection referencing using the example of a table “IsrCar_Old” using a table column name “Rng_15IsrCarId”,

FIG. 7.2 shows an example of a class entry for table column “Rng_15IsrCarId” in table “Sma12_A_IsrCar_Old”, and

FIG. 7.3 shows an example of value list entries for “Rng_15IsrCarId” in table “Sma12_A_IsrCar_Old”.

### DEFINITIONS OF TERMS USED

In the context of this application, the term “automation” is used synonymously for “implementation by means of program routines”; similarly, this applies to its verb and adjective forms and the like. The term “identifiers” represents “syntactically and semantically evaluable naming schemes for databases, tables, table columns, and program code.

The terms “server” and “database” are mostly used in the singular for simplification, but the described properties can also be implemented in a plurality with multi-server and multi-database systems.

The term “database” also refers to “databases and files”, because parts of the data, in particular text data and binary data, can also be stored outside a database and managed by the same.

The term “server” refers to web and data servers and the term “client” refers in particular to desktop, web, mobile clients and embedded systems.

Accordingly, the terms “programming”, “program code” and “program routines” may apply to desktop applications, websites, mobile devices, embedded systems, web servers, data servers and the like.

The term “method” stands for methods and functions in programs.

The term “table” refers to a stand-alone table, or also to the merger (UNION) of several tables. For example, a translation dictionary can be divided into a system translation dictionary and a superimposed corporate translation dictionary; and design templates can be divided into system design templates and corporate design templates, for example.

In addition, the terms of the translation dictionary can be extended with additional information regarding a text and skills analysis for process automation, for example whether a term is a profession or a type of training, and can be supplemented, for example, with networks, weighting factors and context conditions. As an example of a skills analysis from texts, the German patent application DE 10 2014 016 676 A1 “Method for the computer-aided selection of applicants from a plurality of applicants for a given requirement profile” is mentioned.

In particular, “applications” are multi-platform applications for databases, in which programming tasks can take place at different levels and different operating systems, and corresponding program routines generate further program routines from data stored in an associated database for the various levels, platforms and operating systems. These use the identifiers of the database names, table names, column names, and program code identifiers to simplify implementation and minimize errors.

Applications can also only be created for one development platform, one software system, and one operating system.

The term “comprehensive system data” indicates that definitions and standardizations ensure comprehensive usability and include elements such as server definitions, database definitions with table, column, and scheme management, group, user, rights and session management, navigation, logbook, countries, languages, currencies, units of measure, time zones, briefs, document management, project management, design management, metadata, multilingual capability, historization, statistics, simulations, archiving, series tables, dataset and column protection, tracking, developer dictionaries, and translation dictionaries all integrated into one system.

In the context of this application, the term “document management” refers to document management with central design management, the data of which can be optionally stored in files and/or databases.

“Document” in the context of this patent application refers to all possible forms of representable elements, such as forms, web pages, text documents, presentations, tasks, notes, spreadsheets, program code, SQL code, and media, and combinations of these.

The specification defined according to the invention of identifiers for table column names, which can be evaluated syntactically and semantically, and also preferably for table names, database names and identifiers in program codes which are used for generating applications such as client-side query routines, with which the users can query the contents of the databases, makes it possible to generate and manage databases, user interfaces and applications automatically across platforms in combination with comprehensive system data and using program routines. Furthermore, process-controlled creation and customization of databases and documents and their programmability allow a simplified and extended use of robot process automation (RPA).

According to the invention, the relational database system creates the possibility of checking table name identifiers, table column identifiers and database name identifiers for compliance with the respective syntax and semantics in advance, as well as testing the logic and error-free nature of the queries on the client before they are executed on the actual database system on the associated server.

This allows applications to be developed in both a development environment and a production environment.

Another advantage, which is related to the use of the relational database system according to the invention, is that the latter can be used on different server types in a functionally compatible manner and can also be migrated, in particular also automatically, to other server environments with significantly reduced effort compared to known relational database systems. File servers can also be made available for development purposes, database version management, and offline applications, for example.

Another advantage of using identifiers that can be evaluated syntactically and semantically is that complex processes and situations can be simplified and represented in language in a clear and standardized way. This creates the transparency needed to implement cross-database automation. The overall system remains lean and transparent.

As a result, all relevant information, from the database to the user interface, can be provided in a compact form to both the server and the client, which means that the client can now make a data connection independently and assume many tasks of the server intelligently and in many cases no without the need to send queries to the server.

This reduces the load on servers with their storage media, on which the database system according to the invention is implemented, and the user experience is improved by faster and more intelligent reactions. This broad information base enables servers to be programmed and administered automatically and to access comprehensive system and application data intelligently.

In order to create consistent interfaces for desktop and web applications, desktop interfaces with integrated web browsers, such as JavaFX or Windows Forms, or external web browsers accessible via frameworks such as CEF (Chromium Embedded Framework), are preferred for interface display, in particular for desktop applications. Otherwise, interfaces and functionalities, such as those for mobile devices, must be modeled on the web applications in order to achieve similar user experiences.

As a result, user interfaces for desktop and web application are interpreted and/or generated from the database and/or files, so that changes to the interfaces—as long as no business logic has been changed—do not require recompilation to run an application. This effect is amplified by the fact that, as already explained, large portions of database and application generation can be achieved by parameterizing and without changing the business logic.

The program development and its documentation are advantageously carried out in English, so that in this regard, anglicisms can also be found within the German version of this application.

The arrangement and naming of schemes and naming of elements, such as types, table names, and name extensions, are exemplary in nature and can be effected in other ways.

Identifiers and their Name Formation:

As previously stated, in the solution according to the invention, the naming of identifiers, like the names of the table columns and particularly those of the tables and databases, and preferably also the names of variables, methods and classes, are prescribed exactly and monitored by corresponding program routines when creating a new or expanding an existing database system.

In accordance with FIG. 1.1, format templates specify the structural form of an identifier and the use of placeholders. Syntax rules and a developer dictionary (FIGS. 3.1, 3.2, and 5.3) determine which words of the developer dictionary may be used in what manner and sequence within the format templates for naming the identifiers. The syntax rules are preferably supplemented by convention rules, only the most important parts of which are discussed here.

The various components of the word formation are matched in such a way that background information generated from the word formations for the table columns, tables and databases according to the prescribed naming schemes, such as the intended use, the functionality, the data format and the input and output formatting, is clearly visible and this information, for example in the case of automated program generation and execution, can be automatically evaluated by appropriate monitoring program routines.

### Formation of Identifiers:

Within the identifiers for the table column names, table names, and preferably also database names, word formations <w> according to the invention are used for more precise identification. Word formations are preferably composed of words stored in lowercase letters in a developer dictionary, by converting the leading letter of a word to be appended into an uppercase letter. Digits can be added to the individual words provided the identifier allows this in the context. Likewise, the context determines whether the first letter of the word formation is capitalized.

The words of a developer dictionary itself are typically composed of only lowercase letters [a-z]. Preferably, it is provided that an identifier always starts with a letter [a-ZA-Z] by convention, and leading underscores or leading numbers are not permitted.

The format template in FIG. 1.1 specifies the use of a primary separator, for example the underscore character “_”. If a secondary separator is required, for example, an uppercase letter such as “X” can be used, since this rarely appears as the initial letter of a word. This secondary separator must not then be used additionally as a single word in the context, or which is easier to interpret, no word may begin with a separator in that context. Additional separators can be added as needed.

In order to obtain the shortest possible identifiers, frequently used words are preferably abbreviated by one to three letters. Because of this brevity, word formations can be used for all platforms without sacrificing the name length restrictions, for example of servers.

The identifiers generated and/or entered are preferably monitored by a corresponding program routine at the time of input or automated generation to ensure that they comply with the respective naming scheme. Name monitoring also ensures that no keyword violations occur when automatically generating program code for different programming languages and/or servers.

### Word Uniqueness and its Display in Plain Text:

Due to the unambiguous assignability of the individual words to the words stored in a developer dictionary according to the invention, an identifier can be reproduced using the developer dictionary in plain text or, if necessary, in a foreign language translation.

### Evaluation of the Meaning of Names by Word Analysis:

According to FIGS. 3.1 and 3.2, for example, the meaning of the individual words that are related by the naming system is stored in the developer dictionary “Dvn” (Developer Naming) and is preferably evaluated cumulatively and prioritized according to various properties. Identifiers can have one or more prefixes in a closed sequence, which are preferably evaluated with decreasing priority from left to right and have the highest overall priority and can be terminated with one word without a prefix identifier, after which words of the word formation are preferably evaluated from right to left with decreasing priority.

### Database Name Formation:

According to FIGS. 1.1 and 1.2 a database name is composed according to a preferred naming scheme “<b>_<dbc>_<o>_[<a>]_[<v>]”, i.e. “a1_demo_dev_123”.

Here, <b> designates the program development branch, <dbc> the actual database key name (database code), <o> the operation mode, <a> an optional archiving index, and “<v>” an optional software version ID number, so that older database versions are also available for software tests and demonstrations at any time.

An archive index <a> is only required for archiving databases, for example, when transaction data from production, financial accounting and inventories are to be exported annually. The archiving index is advantageously managed in a separate table “TbdSmaArv”, so that the archive data can be automatically archived and accessed. Automated archiving means that the runtime environment can always be kept compact and fast.

Systematization of the database name is advantageous in providing modular and automated use of the databases, which depends in particular on the development branch, the operation mode, the type of archiving and versioning.

### Formation of Table Names:

Table names and their definitions are advantageously managed in a separate table “Sma1_A_Tbd_” and associated table columns are managed in a further table “Sma1_A_TbdDet_” referenced by it.

According to FIGS. 1.1 and 1.2 a table name is composed according to a preferred table name naming scheme “Sma<s>_<t>_<c>_[<x>]_[<n>]”.

For the sake of simplicity, only the second part of the name “<c>_<x>_<n>” or even only <c>, the table code name, is listed as being synonymous with a full table name. A second notation “Sma <s>.”, with dot separator characters instead of underscores, is a special notation in a preferred exemplary embodiment for server types that have their own scheme management. In the context of this patent application, the underscore notation is used synonymously for both notations. A naming scheme corresponds in this case to a server folder in which tables and other objects can be inserted, and to which higher-level permissions and access restrictions can be communicated via permission systems.

An exemplary arrangement of schemes <s> can be seen in FIGS. 2.1 and 2.2. Advantageously, the scheme definition is stored in a separate table “Sma1_A_SMA_”.

The <t> table type is used to standardize and automate common uses of tables in ERP systems: “A” refers to an alpha table that can stand alone and forms the major part of all table types.

The other table types preferably refer to additional tables for the “A” table type:

“H” refers to a table for historization, “P” refers to a table with simulation values for generating forecasts, “S” refers to a statistical table that displays contents of “A” and “H” and archive data in compressed form, “T” refers to a tracking table that logs changes to specified data columns from table Type “A”, and U is a temporary table for caching values.

These additional tables can be automatically added to and removed from alpha tables, with user interfaces and functionalities being updated automatically.

The table name extension <x> is optional. By means of the name extension, identical table structures can be used in a scheme as many times as desired and addressed via the name extension. Advantageously, a separate table “Sma1_A_TbdSma_” stores which table structure is used in which scheme with which name extension.

The numbering index <n> is also optional and is required for series tables, such as geo-data, which is stored in numbered form by country, or production data of a machine, which is stored, for example, in numbered form on a daily basis.

The numbering index <n> is advantageously managed in a separate table “TbdSmaNum”, so that the numbered data tables can be accessed automatically.

The systematization of the table name is used for modular, automated use of the tables. Program routines running on the server and/or on the client connected to the server can use the table names to independently identify the scheme that needs to be accessed, the combination of table types present, and how name extensions and numbering systems should be handled.

Tables can be used according to the invention in one scheme, or globally for multiple schemes simultaneously.

### Formation of Table Column Names:

The formation of table column names in the preferred embodiment is also carried out as shown in FIGS. 1.1 and 1.2.

The table column name of a non-referencing, simple table column is structured according to the scheme “<c>_<w>”, wherein both parameters must start with an uppercase letter.

<c> repeats the table code of its own table so that the origin of the table column is clear, and the name is guaranteed to be unique throughout the database. The <w> parameter refers to a word formation that is constructed semantically and syntactically from the developer dictionary and enables the uniqueness of the table column name within the table.

The structure of referencing table columns will be described later, and these also guarantee a database-wide uniqueness through their naming scheme. As a result, table column names can be uniquely connoted with additional information and functionalities throughout the database.

### Standardized Table Column Elements:

When all tables are set up, certain elements are integrated with their functionalities by default, and additional functionalities are also optionally provided. This procedure significantly increases the performance and functionality of the overall system. Here, too, identification is carried out by means of the naming system.

This will be explained using the example of the language table “Sma1_A_Lan_” (languages) in FIG. 4.1.

The first column “Lan_Id” always contains the numeric primary key, the column name of which is composed according to the scheme “<c>_id” and the bit width of which is 32 bits or 64 bits, depending on the target system. “Auto Increment” is also set for 1:n relations.

### Standardized System Table Columns:

The table footer contains a system block of table columns common to all tables and named according to the scheme “<c>_Sys<w>”. The table footer does not necessarily have to be at the bottom of the table, which makes it easier to insert table columns later.

“LockOn” means that “locked” is switched on and the record must not be used. “HideOn” indicates that the record should not be displayed. “DelOn” indicates that the record is logically deleted. “ProtectOn” indicates that the entire record is protected and can only be edited by the administrator. “SecureOn” indicates that accordingly marked table columns of the record are protected against modification and can only be modified by the administrator. “ArvOn” indicates that it is an automatically created archive or historization accounting record. “TmpOn” is a temporarily freely available flag. “StartDtm” contains the start date (datetime) or the start date of the start of validity of the record. “StartPerId” points to the person who created the record. “EndDtm” contains the date of the last change (datetime) or the end date of the validity period of the record. “EndPer” points to the person who last modified the record.

The functionality of “StartDtm” and “EndDtm” depends on whether a historization is activated for the table and then acts as a temporary scope of validity. Accounting records directed to the past can be automatically periodically swapped from the alpha table (table type A) to the history table (table type H) when historization is activated, and initial accounting records for the removed records are created or maintained to compensate.

Archiving refers to a group of data tables that can be historized or numbered, which can be swapped out periodically and simultaneously to an archive database and which generate or maintain corresponding compensating accounting records and additional statistical accounting records when swapped out. Separate access is preferably provided automatically for swapped out archive databases. Statistics are advantageously additionally supplemented periodically with current figures, so that these reflect a picture of the current overall situation.

### Standardized Table Column ID Lists:

Another powerful element is formed by the referencing ID list with the formats “<c2>[X<y>]_[<as2>X]<c>IdLst” or “<c2>[X<y>]_<id>X[<as2>]<<c>IdLst”.

For example, if it is desired to assign the languages English (Lan_Id=2) and German (Lan_Id=3) to a user, this can be done, for example, by means of a table column “Lan_PerUsrIdLst” in the table “PerUser_”, so that the system recognizes from the syntax and context that this is an ID list with a reference to the “Sma1_A_Lan_” table. For this column, the values “English” and “German” are edited on the automatically generated user interface, which generates a table list ID entry “;2;3;”. The separator here is advantageously a semicolon “;” and is provided in leading and terminating positions. If the string is empty, this means that no selection has been made and all released languages are made available. If the string consists of only one semicolon “;” this means that the user does not speak any language, which in this case makes no sense and should be excluded from the input. ID lists thus have a tristate behavior. Lists of this kind can also be filled without IDs and, for example, with lookup-capable code words that can be displayed transposed in real time by the client via a codeword cache, which greatly improves the readability of the list.

A leading semicolon and a terminating semicolon of an ID list can also be useful for uniquely searching for an ID within the list. For example, a search for “2;” might return results for the IDs “2” or “12” or “22”. A search for “;2;” uniquely returns the ID “2”.

When loading the contents of the ID lists, the ID list is preferably replaced on the server side by a comma-separated value list without enclosing separator characters. For example, an SQL clause here would have the form “IN(2,3)”.

A particularly efficient use of the ID list can be achieved, for example, in conjunction with an integrated translation dictionary. For example, a person can be assigned terms as an ID list, which the client looks up in real time from a dictionary cache and displays and makes editable instead of the IDs. If another user looks up the same person with a different active language, the user received the assigned terms displayed in their own language and can also edit them in their own language or filter according to them.

In any case, when using ID lists a server is relieved of load during the accesses, as it does not have to search sub-tables. In conjunction with a client cache, the server is even further relieved of load because the client takes care of almost all tasks. This opens up the possibility of implementing multilingualism in a resource-saving manner when using the previously described embodiment of the invention.

The principle of using an ID list in conjunction with a client cache can also be applied to other tables.

### Standardized Data Types and Uses:

In order to simplify and ensure universal usability of the data in a relational database of the database system according to the invention, data types that can be selected using database technology are reduced to a few primitive basic types and standardized across servers. The basic types are advantageously “Boolean non-zeroable”, “INT32” (integer 32-bit), “INT64” (integer 64-bit), double, and text. Short binary data and dates and times are represented as text, dates are always related to UTC+0, and zeroable Boolean values are realized with “INT32” and currencies as double with conformant rounding algorithms. The text format can also be used for generic representation of all primitive data types used and for storing searchable objects. Long binary data and non-searchable objects can be handled separately in both the database and in files containing data streams. A reproducible database sorting of texts and a cross-database avoidance of key violations when using UNIQUE KEYS in conjunction with linguistically sortable texts can only be achieved by restricting the usable characters, which in this database system is accomplished via metainformation in the table description. Otherwise, UNIQUE KEYS must be sorted in binary order or be provided with binary character set encoding.

With these standardizations, the database system can independently ensure the integrity of the data contained in it with automatically interchangeable database servers, which is particularly important for mobile offline applications, where server selection is typically restricted.

### Dynamic Referencing of Table Columns:

Table columns can be permanently linked in a classical form in a database of the database system according to the invention, for example as “FOREIGN KEY” with “DELETE CASCADE”.

However, by using the table name components and table column name components contained in the table names and table column names, encoded according to the invention by means of respective table name identifiers and table column identifiers according to a uniform naming scheme for all tables, as listed in the examples in FIG. 1.1, a new advantageous means of dynamic referencing is obtained for referencing table columns, in which optionally database-based and/or software-based links can be implemented automatically and, due to the characteristics of the identifiers, server and client can implement user interface creation, user interface customization, data integration and functionalities connoted with identifiers by means of program routines.

Both the classical database references and the software-side references of tables can be equally well defined by means of the identifiers, by advantageously forming table column identifiers in a uniform manner and the column description having a keyword <key>, such as “FD”, “FR” or “FK”, describing the embodiment of the referencing, which is explained in more detail in the next section. Additional specifications can be stored in the description of a table column by means of additional metadata, so that the entire table can be generated from this information in a database and linked and can be duplicated using something like “Copy and paste”.

The definition of identifiers with additional key metadata (key) is advantageously carried out according to the naming scheme from FIG. 1.1 “<key>[_<c>_<fln>[_<fln>] . . . [_<fln>]]”. First, a key term <key> is listed, and then the separate table code <c>, or, for 1:1-relations, the table code <c2> of the target table, followed by a list of included field names or column names.

Key terms for metadata include, for example, “PK” for primary key, “UK” for “UNIQUE KEY”, “IX” for index, “FD” for database-based referential integrity with deletion propagation, “FR” for database-based referential integrity without deletion propagation, and “FK” for software-based referencing without deletion propagation.

For example, general meta-information within the table column description has the format “+| . . . |+” and encloses the meta-information with defined characters, such as “+|” and “|+”. Any number of meta-information items can appear in a column description or text. The definition of metadata is advantageously provided in one or more separate tables.

This compact table display, in which all relationships can be viewed and edited at a glance, represents a significant simplification compared to the prior art, in which this information is usually distributed at different locations in the database system.

Dynamic software referencing greatly relieves the load on a server in an advantageous manner. Furthermore, a dynamic referencing may include cascading and/or implicit multiple referencing, as shown below, which classical relational database systems cannot reproduce.

In the dynamic referencing according to the invention of table columns to tables, according to FIG. 1.1, three cases can be advantageously distinguished: referencing to a normal table, referencing to tables with categorizations and typings (Cat, Cat1, Cat2, Cat3, Type), and referencing to value list collections (Rng) and text block collections (Txt), wherein value list collections and text block collections in turn contain an internal referencing to a classification (Cla) permanently associated with them.

### Examples of Dynamic Referencing are Shown in FIGS. 6.1 to 6.3:

If as shown in FIG. 6.1 no explicit name extension <y> is specified for searching the referenced table, the table name searched for is first formed from “<c2>_”+“<c>”+“[X<x>]_”. Thus a table column named “Cat1_Perid” in a “Per_Lead_” table would trigger a search for a table named “Cat1_PerXLead”. The search is advantageously performed first in the company's own scheme (1), then in the global administration (2), and finally in global company data (3).

If no table with the same name is found for referencing, a reduced table name extension is determined for a further search of the table referencing.

If at least one secondary separator “X” is included in the name extension of the searched table, the last secondary element is removed from the name extension first and the search is restarted. The next table name searched for from “Cat1_PerXLead_” would therefore be “Cat1_Per”.

This operation is repeated until no further secondary separator “X” is included in the table name extension.

Finally, the last table name to be searched for referencing would be a table name without a name extension, hence in this example the table “Cat1_”, which is not shown in FIGS. 6.1 to 6.3.

If, according to FIGS. 6.2 and 6.3, an explicit name extension <y> is specified to search for the referencing in the identifier, the table name searched for is “<c2>_”+“<y>_”, where <y> can also be an empty string.

Thus in the example of FIG. 6.2 with a column name “Cat1XPer_Perid”, originating from a person table “Per_Lead_”, regardless of its own table name extension “Lead”, the table “Cat1_Per_” would always be searched without further reductions.

In the example of FIG. 6.3 with a column name “Cat1XPerXLead_Perid”, originating from a person table “Per_Lead_”, regardless of its own table name extension “Lead”, the table “Cat1_PerXLead_” would always be searched without further reductions.

Furthermore, in the tables of the database system according to the invention, different referencing methods can preferably also be used side by side and in different combinations.

Collections within referenced tables can be referenced according to FIG. 7.1 with an additional parameter <id>:

Value list collections (Rng) and text block collections (Txt) are referenced according to FIGS. 1.1 and 7.1 using the format “<c2>[X<y>]_<id>X[<as2>]X<c>Id”. In other words, an <id> with a separator “X” has been added to the referencing. <id> refers to a classification ID that is integrated as a Cla_RngId column in value list collections and as a Cla_TxtId column in text block collections and is used to select a collection within a value list collection or text block collection.

According to the example in FIG. 7.1, a table “Sma12_A_IsrCar_Old” contains the column name “Rng_15IsrCarId”, where the number “15” corresponds to the <id>.

Analogous to the dynamic referencing of FIGS. 6.1 to 6.3, here referenceable tables are searched in an identical manner in the prioritized order (1) to (6), where the search would then be extended to “Rng_”, which is not shown here.

The referenced table, found with priority, now contains a collection identified by the <id>. To obtain the collection, a filter with “Cla_RngId=15” is set in the “Rng” value list collection and a filter with “Cla_Id=15” is set in the assigned classification. Thus, a single identifier enables automated handling of collections, from database management through to the user interfaces.

The system of dynamic referencing can of course also be implemented in other variants, with different tables and with different names, so that all statements are necessarily exemplary in nature. The implementation is carried out according to the invention via corresponding program routines which are prepared by a client computer as a query, then transferred to a database server and executed by this server, which reads out the data records entered in the dynamically referenced table columns and transfers them to the client. The particular advantage obtained here is that the queries of tables with dynamically referenced or even multiply referenced table columns can already be prepared on the client computer due to the naming according to the invention of the table column names, table names and database names of the database system according to the invention according to a consistent naming scheme, before they are transferred to the server. This is one of the reasons why the associated server is significantly relieved of load.

### Using Parameters in Value List Collections and Text Block Collections:

Values list collections (Rng) and text block collections (Txt) not only reproduce selectable contents according to FIGS. 7.2 and 7.3, but also provide parameters for calculations and evaluations, such as evaluable texts, floating point numbers, and bit patterns.

Since each value list collection (Rng) and each text block collection (Txt) must necessarily have an assigned entry in the assigned classification (Cla) for selectability, the names and functionality of the parameters of the collections are advantageously defined in a classification entry.

For insurance, for example, according to FIG. 7.2 a classification “deductible” can now be created and the first value-parameter heading with “Deductible in EUR” and the second value-parameter heading with “Discount in %” and the corresponding input and output formatting can be defined.

Subsequently, in the corresponding value list according to FIG. 7.3, an entry “Excess 0 EUR” with the first value parameter “0” and the second value parameter “0” is recorded and the reference of the classification to “Excess” is entered.

Now the process is repeated, for example, with “Excess 1000 EUR” and the values “1,000” and “10%” and with “Excess 2000 EUR” and the values “2,000.00” and “20%”.

The value list now has 3 entries with the classification “Excess”, which can be displayed in a document and selected. The classification (Cla) table provides the “Excess” heading for display in the document and the headings “Excess in EUR” and “Discount in %” for the column displays.

The user can then select one of the three value list entries during data collection on the user interface, sees the column headings with the listed excess amounts in EUR and discounts in percent during selection, and can now make a selection based on this background information. Parameter information can be advantageously displayed or hidden. A program routine can recalculate the tariff after user selection, by taking into account the selected discount in percent.

The same applies to text block collections. If, for example, a text block “Garage vehicle . . . ” is inserted in an insurance contract for vehicles and this entry is associated with a discount of 15%, a program routine can also read this out and take it into account.

These are two greatly simplified examples. However, they clearly show that tariffs can be defined to a very large extent using table entries and parameterizations without changing program routines.

Using the historization function, for example, tariffs, value list collections and text block collections can now be automatically historized and a user can thus calculate tariffs at any time, even for tariff changes in the future.

If a second vehicle line “Oldtimer” is to be set up, then only the corresponding tariffs, value list and text block collections and extended program routines need to be copied and revised and extended. Optionally, elements for similar lines can also be shared.

If it is decided to specialize in insurance software, a user will develop documents and/or graphical interfaces to help a user create and test new tariff lines. This enables insurance departments to generate, simulate and test tariffs without the need for IT specialists. Furthermore, all information is easily and clearly retrievable from a system and not hidden in background information or ancillary systems.

### Simplified Cross-Platform Programming:

Programming using identifiers according to the invention can be applied to all programming components, such as system, user, server and documentation programming. The syntactic and semantic naming of the identifiers clearly indicates their purpose, data formats and input and output formatting, and checks and automated further processing steps can be implemented.

In particular, this makes it possible, for example, for declarations or methods to be ported to other platforms in isolation without first having to read in and evaluate their context or even the entire program code. However, it is possible to disregard the strict naming of identifiers within defined ranges in order to facilitate the creation of program codes. These ranges must then be read in and analyzed completely to reconstruct the background information that the identifiers otherwise provide.

Simplified, standardized, cross-platform programming, also called user programming or business logic, is characterized by the fact that the program code is immediately executable on other platforms by means of a simple code port. This eliminates complex and platform-specific functionalities, resulting in a simplification of the programming language scope.

Regardless of simplified user programming, system programming and specific programming techniques, which provide their functionality through methods, APIs or other types of data exchange, can take advantage of the full language scope of a programming platform.

The automated detection of table column formats has already been explained elsewhere. The identifiers are advantageously designed in such a way that the lengths of texts and binary data do not necessarily need to be recognizable, since these values can be read inter alia out of the database and stored in the table definition and are usually not required in the program code, e.g. in the case of variable naming.

### Data Synchronization Via Git Folders:

The relational database system according to the invention represents an integral production and development system, which if desired can also manage different programming platforms, databases, documents and designs.

For this purpose a separate database and program version control “Git” is advantageously introduced, which copies database copies from general databases and program code copies from the various programming platforms into a general Git folder according to FIG. 5.2 with the button “Transfer Platforms To Git Folders” in FIG. 5.1.

The Git folder preferably represents the current databases and the current programming code of all platforms. For data protection reasons, only developer databases with anonymized or fictitious data are preferably stored.

The Git folder is advantageously integrated into a source control system such as “Git” and synchronized with a hub for the purpose of data exchange with other developers.

After synchronization and verification, the program codes are copied back to their platforms with the “Transfer Git Folders To Platforms” button.

When copying to the Git and copying back, different sources and targets can be specified, so that the current development platform, in particular for web developments, can be changed during this process.

FIG. 5.2 shows the different Git folders that are assigned to platforms or data: “com” contains the common programming code (business logic), “data” contains data for operating and testing the database, “dbs” database copies of the current developer database in ACCDB and SQLite format, “jva” contains Java files, “ktl” contains Kotlin files, “mobile” has data for mobile applications, “py” Python data, “static” documents, JavaScript and CSS files, “vba” VBA source code files and “vbaZip” compressed VBA client files.

The “static” folder is always matched with the currently active web development platform.

The buttons “VBA To Corn”, “Kotlin To Corn”, “PyFlask To Corn” and “Java To Corn” port the respective business programming of the platform to the “corn” folder.

Using the buttons “Corn To VBA Git”, “Corn To Kotlin Git”, “Corn To Py Git”, “Corn To JS Git” and “Corn To Java Git”, the “corn” folder is ported back to the Git folder of the respective programming platforms.

Since databases are also preferably included in the versioning, checks on changes can be carried out with appropriate tests at any time.

In addition, database changes can be logged and used for an update or upgrade.

### Application Extension Sequence:

Based on FIGS. 5.1 ff., the process sequence of an application extension for system developers using the relational database system according to the invention is described.

The development process begins in FIG. 5.1 in the upper left corner with “Update Database System”, i.e. the region for updating the database system. Therefore, the following first describes a typical change to a database within a development process.

### Reuse of Data Structures and Documents:

First, in company 1, which is located in Scheme 10 according to the above-mentioned example of FIG. 2.1, a new person master with lead data with a multiple assignment of addresses is to be generated and the name extension “Lead” is to be used. To do this, the structure of an existing person master “Per” is copied and renamed to “Sma10_A_Per_Lead_”, and the structure of a person address data extension “PerAdr” is copied and renamed to “Sma10_A_PerAdr_Lead_”.

For the “Per_Lead_” and “PerAdr_Lead_” tables, the existing “Per” and “PerAdr” interfaces are also used for the interface display, which is automated using dynamic referencing.

### Generating and Incorporating New Tables:

In addition, a new table “Sto” for “Stock”, “Storage of products (Pro)”, is to be created in company 1.

The table structure “Sto” is created afresh according to FIG. 5.5 using standard platform developer tools and saved as table “Sma10_A_Sto_”. This is a greatly simplified model of product storage that can be extended at any time.

Since there is no product table “Pro” in Scheme 10, the system will automatically refer the referencing of the “Pro_StoId” table column in FIG. 5.5 to the “Pro” company-wide product table in Scheme 2 in accordance with FIG. 2.1.

As described earlier, the table “Sto” in FIG. 5.5 has a defined structure: in the first column the definition of the “Primary Key” is given, followed by table-specific columns and finally the system columns of “SysLockOn” to “SysEndPerId” follow.

In the present case of a VBA-Access database, the next step is to activate the button “Field Descriptions” from FIG. 5.1. A special feature of the Access database type is that table column aliases exist, which are now populated automatically.

The “Table Definitions” button reads the table definitions from the active database and writes them to the “Tbd” and “TbdDet” tables for each table code name. If a new table code name appears, here “Sto”, this is added along with the table columns. If there is no table for a table definition, all related definitions are deleted.

During this process, the table schema listings are also matched and updated. Accordingly, for the new tables “Per_Lead”, “PerAdr_Lead” and “Sto”, a table entry “Per”, “PerAdr” and “Sto” are generated for schema 10.

The “Check Tables” button can be used to check all tables and table structures for correct naming, and incorrect formats or names or missing relation tables are displayed.

All entries for managing the tables have now been completed.

Another user interface must now be created for the “Sto” table code. To do this, select the “Sto” table code in the combo box below the “Table Docs” button and then activate the “Table Docs” button. If a table should have linked sub-tables, they are created immediately and can be used in a common user interface.

Preferably, it can be provided to update the corresponding interfaces in one run for all data-linked documents, so this can be executed by activating the “All Docs” button, which activates a corresponding program routine, which executes the updates.

### Main Menu Updates:

In a next method step, as the last manual entry menu entries are recorded in the Main Navigation, table “Sma1_A_Nav_”, for the new documents, specifying the user group permissions.

All navigation menus of the user groups are updated by means of the “Main Navigation” button, which makes the new documents selectable and editable via the main menu.

For example, documents can also be opened from other documents with parameter propagation, but this requires manual modification of a document and user programming, wherein automatically generated and automatically updatable form components can be mixed with manual proportions.

This means that documents can be copied and managed in variants without losing their ability to be updated automatically. In addition, documents can be provided with business programming and elements that can be evaluated graphically and textually by interpreters.

### Generating a New Database:

To generate a new database of the database system according to the invention, activate the button “Copy Databases” after having previously selected a target database format, wherein a database of the original format can also be selected.

### Additional Buttons for System Maintenance and Expansion:

The “Enumerations” button automatically updates program code enumerations from information from predefined database tables.

The “Developer Naming” button opens an overview form (FIG. 5.3) for searching and editing developer words according to the data structure according to FIG. 3.1.

The “Dictionary” button opens an overview form (FIG. 5.4) for searching and editing the central translation dictionary.

The “Documents” button can be used to update an existing document that was previously selected in the selection field below it.

The “Field Formats” button (column formats) updates all documents according to changed column formats and the “Translate Database” button updates all table translations from the central dictionary.

For users of the database system according to the invention, dedicated interfaces for the administration and generation of databases are preferably provided, so that changes can be made intuitively without having to understand the system in the background.

As was recognized by the applicant, identifiers for table column names, table names, database names and identifiers in program codes that can be evaluated syntactically and semantically by program routines may at first appear to impose restrictions on the freedom of system design, the use of third-party libraries and the use of proven programming techniques. However, when considering a complex overall system of relational databases, this technology makes it possible to implement more complex database systems and applications in a shorter time and with a significantly reduced effort than with traditional development methods.

The central development goal of the database system, the dynamic customization of databases, user interfaces and functionalities according to original low-code and no-code (LCNC) principles and/or through robot process automation (RPA), artificial intelligence (AI) and machine learning (ML), can be realized with this technology.

1-14. (canceled)

15. A relational database system to be implemented on a computer system having at least one processor and a storage unit, the relational database system comprising:
at least one relational database having a database structure including a multiplicity of interlinked database tables for receiving data to be processed, each database table having a table name and a multiplicity of table columns to be identified by respective table column names; and
said table column names, as identifiers, being at least one of:
formed of a plurality of different uniquely identifiable table column name naming schemes, containing one or more word formations of identifiable individual words, and configured to be syntactically and semantically evaluated by program routines, or
formed of one or more different uniquely assignable table name naming schemes, including at least one table type, a table code name, an optional table name extension, and a database naming scheme, and configured to be syntactically and semantically evaluated by program routines.

16. The relational database system according to claim 15, wherein:
said at least one relational database includes a plurality of relational databases; and
said database names, as identifiers, being constructed from one or more different, uniquely assignable database naming schemes, including at least one database code name, an operation mode and an archiving index and being configured to be syntactically and semantically evaluated by program routines.

17. The relational database system according to claim 15, wherein:
at least one of said table column name naming schemes or said table name naming schemes or said database name naming schemes are primarily structured by a primary separator, configured to be formed of one or more letters; and
within said primary structures, substructures are configured to be provided by one or more further separators, in turn configured to be formed of one or more letters, permitting a syntactic and semantic analysis to be carried out over multiple structural levels of naming schemes.

18. The relational database system according to claim 15, wherein words for said word formations are stored in a separate developer dictionary and contain specifications for each word, the specifications being selected from data format, input and output formatting, metadata, prefix functionality, class and module name functionality, keyword indicators, and usability.

19. The relational database system according to claim 18, wherein said developer dictionary is used for syntactic and semantic verification of a use of identifiers including at least one of said table column names or said table names or database names or identifiers in software code.

20. The relational database system according to claim 19, wherein all contextual information required for an isolated porting of declarations and methods within a program code arises from identifiers in the program codes, ensuring that in order to port a code sequence, an entirety of the program code does not need to be used and for non-typed programming languages, data types and usages are derivable from the identifiers.

21. The relational database system according to claim 15, wherein upon copying said tables, identical table structures reference different target tables by using different prioritizations in a context-dependent manner, depending on their scheme and their name extension.

22. The relational database system according to claim 21, wherein upon using syntactic and semantic analysis of said table and table column identifiers, supported by metadata, tasks of interface generation, interface customizations, data integrations and functionalities connoted with identifiers are configured to be implemented automatically by program routines for database structures and thus an entire database is configured to be designed in an editable form on a user interface and provided with specific functionalities and behaviors.

23. The relational database system according to claim 22, wherein IDs of a referencing, being concatenated together by separators in text form, form an ID list configured to also be dynamically referenced and automatically evaluated.

24. The relational database system according to claim 15, wherein the database system is configured for automated use of value lists and text block collections with integrated parameters for calculations with dynamic referencing.

25. The relational database system according to claim 15, wherein the computer system includes an SQL server and at least one client coupled to the SQL server, and SQL statements include placeholders configured to be completed at run time in a context-dependent manner, to automatically and dynamically address databases and said tables with associated table columns of the relational database system.

26. The relational database system according to claim 25, wherein said database system is configured to segment the SQL statements into one or more security-oriented sections not being modifiable by the client, and into one or more client-side modifiable sections, to increase database security against manipulation attempts.

27. A computer system, comprising:
at least one processor; and
a storage unit connected to said at least one processor for data exchange;
the computer system configured to at least one of implement or store the relational database system according to claim 15 in said storage unit for data processing by said at least one processor.

28. A non-transitory computer-readable data carrier containing program code and configured to at least one of implement or execute the relational database system according to claim 15 on a computer system including at least one processor and at least one storage unit.
